(19) United States
(12) Patent Application Publication
(10) Pub. No.: US 2026/0271048 A1
(43) Pub. Date: Sep. 10, 2026

(54) DEVICES AND METHODS OF COMMUNICATION

(71) Applicant: Lenovo (Beijing) Limited, Beijing (CN)

(72) Inventors: Ran Yue, Beijing (CN); Lianhai Wu, Beijing (CN); Haiming Wang, Beijing (CN)

(73) Assignee: Lenovo (Beijing) Limited, Beijing (CN)

(21) Appl. No.: 19/167,340

(22) PCT Filed: Jul. 13, 2023
(86) PCT No.: PCT/CN2023/107235

§ 371 Date: Sep. 19, 2025

(51) Int. Cl. H04W 72/563; H04W 68/02

(52) U.S. Cl. CPC H04W 72/563; H04W 68/02

(57) ABSTRACT

Various aspects of the present disclosure relate to devices and methods of communication. Upon determination that a first SDT procedure overlaps at least with a second SDT procedure, a UE determines an ongoing procedure. In this way, an interaction among SDT procedures may be simplified, and communication efficiency may be improved.

### TECHNICAL FIELD

The present disclosure relates to wireless communications, and more specifically to devices and methods of communication for small data transmission (SDT).

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Currently, SDT in an inactive state or an idle state has been approved so as to save signaling overhead. Further, it has been agreed to support mobile originating-SDT (MO-SDT) and mobile terminating-SDT (MT-SDT) procedures.

### SUMMARY

The present disclosure relates to methods, apparatuses, and systems that support handling of overlap among at least SDT procedures. By selecting one procedure as an ongoing procedure, a communication device may handle the overlap scenario. In this way, an interaction among SDT procedures may be simplified, and communication efficiency may be improved.

Some implementations of the method and apparatuses described herein may include: determining that a first SDT procedure overlaps at least with a second SDT procedure; and determining an ongoing procedure.

In some implementations of the method and apparatuses described herein, determining that the first SDT procedure overlaps at least with the second SDT procedure may comprise: determining that the first SDT procedure and the second SDT procedure are started; or determining that the first SDT procedure, the second SDT procedure and a non-SDT procedure are started.

In some implementations of the method and apparatuses described herein, the first SDT procedure may be an MO-SDT procedure or an MT-SDT procedure, and the second SDT procedure may be an MO-SDT procedure or an MT-SDT procedure.

In some implementations of the method and apparatuses described herein, determining the ongoing procedure may comprise: determining information of prioritization among the first SDT procedure and the second SDT procedure; and selecting, based on the information of the prioritization, one of the first and second SDT procedures as the ongoing procedure.

In some implementations of the method and apparatuses described herein, determining the information of the prioritization may comprise: receiving, from a base station, an indication comprising the information of the prioritization.

In some implementations of the method and apparatuses described herein, receiving the information of the prioritization may comprise: receiving, from the base station, the indication in a paging message associated with an MT-SDT procedure.

In some implementations of the method and apparatuses described herein, the information of the prioritization may indicate: an MO-SDT procedure is prior to an MT-SDT procedure; or the MT-SDT procedure is prior to the MO-SDT procedure.

In some implementations of the method and apparatuses described herein, determining the ongoing procedure by: determining a starting time point of the first SDT procedure and a starting time point of the second SDT procedure; and selecting, as the ongoing procedure, one of the first and second SDT procedures based on the starting time point of the first SDT procedure and the starting time point of the second SDT procedure.

In some implementations of the method and apparatuses described herein, the starting time point of the first SDT procedure may be one of the following: a time point in which data associated with the first SDT procedure arrives; a time point in which the data associated with the first SDT procedure is transmitted; a time point in which a radio resource control (RRC) resume procedure associated with the first SDT procedure is initiated; a time point in which a set of conditions for initiating the first SDT procedure is fulfilled; or a time point in which a paging message associated with the first SDT procedure is received.

In some implementations of the method and apparatuses described herein, the starting time point of the second SDT procedure may be one of the following: a time point in which data associated with the second SDT procedure arrives; a time point in which the data associated with the second SDT procedure is transmitted; a time point in which an RRC resume procedure associated with the second SDT procedure is initiated; a time point in which a set of conditions for initiating the second SDT procedure is fulfilled; or a time point in which a paging message associated with the second SDT procedure is received.

In some implementations of the method and apparatuses described herein, determining the ongoing procedure may comprise: determining a first resource selected for the first SDT procedure and a second resource selected for the second SDT procedure; and selecting, as the ongoing procedure, one of the first and second SDT procedures based on priorities of the first and second resources.

Some implementations of the method and apparatuses described herein may further include: cancelling or stopping or suspending one of the first and second SDT procedures that is unselected as the ongoing procedure.

Some implementations of the method and apparatuses described herein may further include: determining that the one of the first and second SDT procedures is unsuccessfully completed; or determining that the one of the first and second SDT procedures is successfully completed.

Some implementations of the method and apparatuses described herein may further include: in accordance with a determination that the one of the first and second SDT procedures is unsuccessfully completed, maintaining in an inactive state.

Some implementations of the method and apparatuses described herein may further include: transmitting, to a base station, information of the determination of the ongoing procedure.

In some implementations of the method and apparatuses described herein, transmitting the information of the determination of the ongoing procedure may comprise: transmitting a message indicating the information of the determination of the ongoing procedure.

In some implementations of the method and apparatuses described herein, the message may have a cause value indicating the information of the determination of the ongoing procedure; or the message may have an information element indicating the information of the determination of the ongoing procedure.

### BRIEF DESCRIPTION OF THE DRAWINGS

FIG. 1 illustrates an example of a wireless communications system that supports handling of overlap among at least SDT procedures in accordance with aspects of the present disclosure.

FIG. 2A illustrates an example scenario of overlap among at least SDT procedures in accordance with aspects of the present disclosure.

FIG. 2B illustrates another example scenario of overlap among at least SDT procedures in accordance with aspects of the present disclosure.

FIG. 3 illustrates an example of a process that supports handling of overlap among at least SDT procedures in accordance with aspects of the present disclosure.

FIG. 4 illustrates an example of a device that supports handling of overlap among at least SDT procedures in accordance with aspects of the present disclosure.

FIG. 5 illustrates an example of a processor that supports handling of overlap among at least SDT procedures in accordance with aspects of the present disclosure.

FIG. 6 illustrates a flowchart of a method that supports handling of overlap among at least SDT procedures in accordance with aspects of the present disclosure.

### DETAILED DESCRIPTION

As known, a SDT procedure may be performed either by a random access (RA) procedure with 2-step RA type or 4-step RA type (i.e., RA-SDT) or by configured grant (CG) Type 1 (i.e., CG-SDT). For convenience, a CG resource configured for SDT may also be referred to as a CG-SDT resource, and an RA resource configured for SDT may also be referred to as an RA-SDT resource. An RA resource configured for UE may also be used for a SDT procedure.

As also known, an MO-SDT procedure and an MT-SDT procedure have been proposed for SDT enhancement. However, it is still unclear how to handle interaction among these SDT procedures, e.g., how to handle overlap between these SDT procedures, how to handle overlap among these SDT procedures and one or more non-SDT procedures, and so on.

In view of this, embodiments of the present disclosure provide a solution of handling of overlap among at least SDT procedures. In the solution, upon determination that a first SDT procedure overlaps at least with a second SDT procedure, a UE determines an ongoing procedure.

In this way, by determination of an ongoing procedure, an interaction among SDT procedures may be simplified, and communication efficiency may be improved.

Aspects of the present disclosure are described in the context of a wireless communications system.

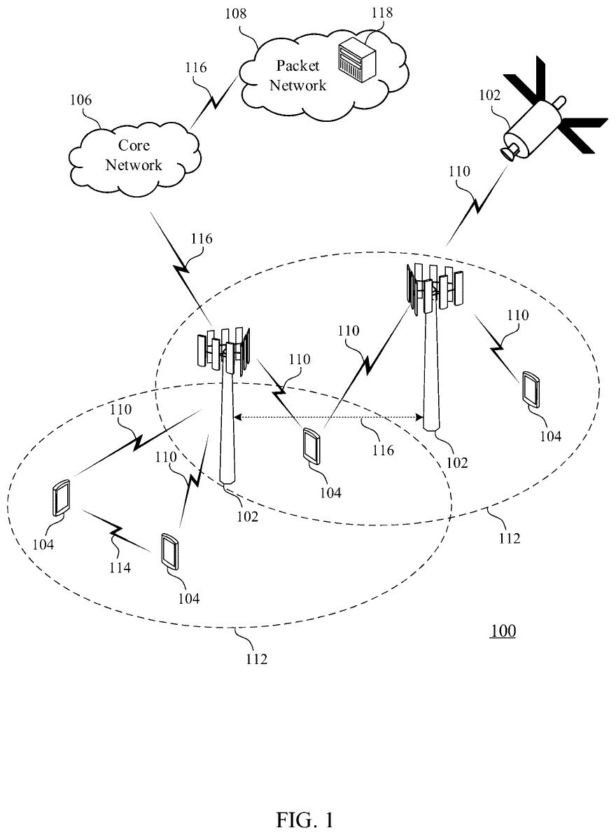

FIG. 1 illustrates an example of a wireless communications system 100 that supports handling of overlap among at least SDT procedures in accordance with aspects of the present disclosure. The wireless communications system 100 may include one or more network entities 102 (also referred to as network equipment (NE)), one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU 160.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FRI may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In the context of the present disclosure, the term “a connected state” may be interchangeably used with “an RRC_CONNECTED state”, the term “an idle state” may be interchangeably used with “an RRC_IDLE state”, and the term “an inactive state” may be interchangeably used with “an RRC_INACTIVE state”.

In some scenarios, the UE 104 may enter an inactive state or an idle state. In some embodiments where the UE 104 is in the inactive or idle state, small and infrequency uplink (UL) data may arrive at the UE 104. The UE 104 may perform a SDT procedure to transmit the UL data to the network entity 102. This procedure is a MO-SDT procedure.

In some embodiments where the UE 104 is in the inactive or idle state, the network entity 102 may transmit a paging message for the UE 104. The paging message may be associated with SDT. In other words, the paging message may indicate the SDT. Upon reception of the paging message, the UE 104 may transmit, to the network entity 102, a response to the paging message. The network entity 102 may transmit downlink (DL) data to the UE 104 while the UE 104 maintains in the inactive state or the idle state. This procedure is a MT-SDT procedure.

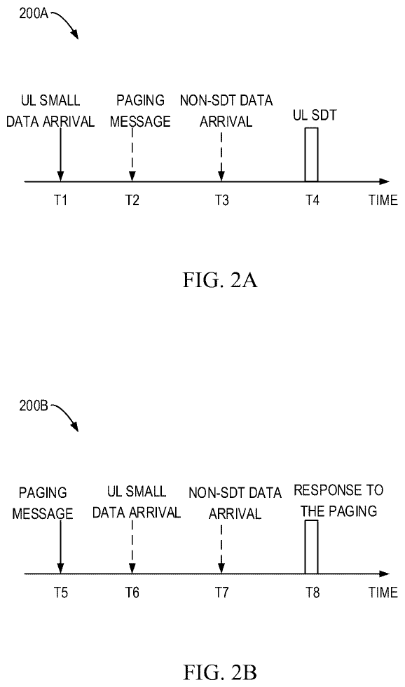

FIG. 2A illustrates an example scenario 200A of overlap among at least SDT procedures in accordance with aspects of the present disclosure. As shown in FIG. 2A, UL small data may arrive at a timing T1. In this case, an RRC connection resume procedure may be initiated by an RRC layer of the UE 104. The RRC layer or a lower layer of the UE 104 may consider that the first available configured grant (CG) resource is valid or may use the first available CG resource to transmit pending or buffered or arrived UL small data. The first available CG resource may be located at a timing T4 as shown. The RRC layer of the UE 104 may determine that an UL SDT procedure is ongoing at the timing T1. It is to be understood that the CG resource is merely an example, and an available resource to perform the UL SDT procedure may also be an RA-SDT resource or any other suitable resources.

Continuing to refer to FIG. 2A, in some scenarios, a paging message associated with a MT-SDT may be received at a timing T2. In this case, an MO-SDT procedure and a MT-SDT procedure are overlapped. In some scenarios, a non-SDT UL data may also arrive at a timing T3. Although the timing T3 is shown as being later than the timing T2, it is to be understood that the timing T3 may be earlier than the timing T2 and later than the timing T1. In this case, an MO-SDT procedure, an MT-SDT procedure and a non-SDT procedure are overlapped.

FIG. 2B illustrates another example scenario 200B of overlap among at least SDT procedures in accordance with aspects of the present disclosure. As shown in FIG. 2B, a paging message associated with a MT-SDT may be received at a timing T5. An RRC layer of the UE 104 may initiate an RRC connection resume procedure. The RRC layer or a lower layer of the UE 104 may determine to respond to the paging message with a random access (RA) resource. The RA resource may be located at a timing T8 as shown. The RRC layer of the UE 104 may determine that a DL SDT procedure is ongoing at the timing T5. It is to be understood that the RA resource is merely an example, and an available resource for responding to the paging message may also be a CG-SDT resource or any other suitable resources.

Continuing to refer to FIG. 2B, in some scenarios, UL small data may arrive at a timing T6. In this case, an MO-SDT procedure and a MT-SDT procedure are overlapped. In some scenarios, a non-SDT UL data may also arrive at a timing T7. Although the timing T7 is shown as being later than the timing T6, it is to be understood that the timing T7 may be earlier than the timing T6 and later than the timing T5. In this case, an MO-SDT procedure, an MT-SDT procedure and a non-SDT procedure are overlapped.

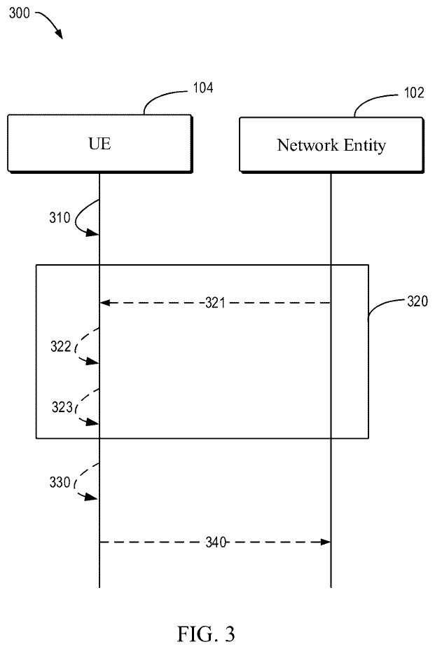

Embodiments of the present disclosure provide a solution of handling the overlap among these procedures. The solution will be described in connection with FIG. 3 below.

FIG. 3 illustrates an example of a process 300 that supports handling of overlap among at least SDT procedures in accordance with aspects of the present disclosure. For the purpose of discussion, the process 300 will be described with reference to FIG. 1. The process 300 may involve the UE 104 and the network entity 102 as illustrated in FIG. 1. It is to be understood that the steps and the order of the steps in FIG. 3 are merely for illustration, and not for limitation.

As shown in FIG. 3, the UE 104 may determine 310 that a SDT procedure (for convenience, also referred to as a first SDT procedure herein) overlaps at least with another SDT procedure (for convenience, also referred to as a second SDT procedure herein).

In some embodiments, if both the first SDT procedure and the second SDT procedure are started, the UE 104 may determine that the first SDT procedure overlaps with the second SDT procedure. In some embodiments, if the first SDT procedure, the second SDT procedure and a non-SDT procedure are all started, the UE 104 may determine that the first SDT procedure overlaps with the second SDT procedure and the non-SDT procedure.

In some embodiments, the first SDT procedure may be any of an MO-SDT procedure and an MT-SDT procedure. In some embodiments, the second SDT procedure may be any of an MO-SDT procedure and an MT-SDT procedure.

In some embodiments, if data associated with an MO-SDT procedure arrives, the UE 104 may determine that the MO-SDT procedure is started. In some embodiments, if data associated with an MO-SDT procedure is transmitted, the UE 104 may determine that the MO-SDT procedure is started. In some embodiments, if an RRC connection resume procedure associated with an MO-SDT procedure is initiated, the UE 104 may determine that the MO-SDT procedure is started. In some embodiments, if a set of conditions for initiating an MO-SDT procedure is fulfilled, the UE 104 may determine that the MO-SDT procedure is started. In some embodiments, if an MO-SDT procedure is initiated, the UE 104 may determine that the MO-SDT procedure is started.

In some embodiments, if data associated with an MT-SDT procedure arrives, the UE 104 may determine that the MT-SDT procedure is started. In some embodiments, if data associated with an MT-SDT procedure is transmitted, the UE 104 may determine that the MT-SDT procedure is started. In some embodiments, if an RRC connection resume procedure associated with an MT-SDT procedure is initiated, the UE 104 may determine that the MT-SDT procedure is started. In some embodiments, if a set of conditions for initiating an MT-SDT procedure is fulfilled, the UE 104 may determine that the MT-SDT procedure is started. In some embodiments, if an MT-SDT procedure is initiated, the UE 104 may determine that the MT-SDT procedure is started. In some embodiments, if a paging message associated with an MT-SDT procedure is received, the UE 104 may determine that the MT-SDT procedure is started.

Continuing to refer to FIG. 3, the UE 104 may determine 320 an ongoing procedure. That is, the UE 104 may select one procedure from the overlapped procedures as the ongoing procedure.

In some embodiments, the UE 104 may determine information of prioritization among the first SDT procedure and the second SDT procedure. In some embodiments, the information of the prioritization may be predefined.

In some embodiments, the information of the prioritization may be configured. With reference to FIG. 3, the network entity 102 may transmit 321, to the UE 104, an indication comprising the information of the prioritization. Based on the indication, the UE 104 may determine the information of the prioritization. In some embodiments, the network entity 102 may transmit the indication in a paging message associated with an MT-SDT procedure. It is to be understood that the indication may be transmitted in any other suitable ways and the present disclosure does not limit this aspect.

In some embodiments, the information of the prioritization may indicate that an MO-SDT procedure is prior to an MT-SDT procedure. In some embodiments, the information of the prioritization may indicate that an MT-SDT procedure is prior to an MO-SDT procedure.

Based on the information of the prioritization, the UE 104 may select one of the first and second SDT procedures as the ongoing procedure.

Continuing to refer to FIG. 3, in some embodiments, the UE 104 may determine 322 a starting time point of the first SDT procedure and a starting time point of the second SDT procedure.

In some embodiments, the starting time point of the first SDT procedure may be a time point in which data associated with the first SDT procedure arrives. In some embodiments, the starting time point of the first SDT procedure may be a time point in which the data associated with the first SDT procedure is transmitted. In some embodiments, the starting time point of the first SDT procedure may be a time point in which an RRC resume procedure associated with the first SDT procedure is initiated. In some embodiments, the starting time point of the first SDT procedure may be a time point in which a set of conditions for initiating the first SDT procedure is fulfilled. In some embodiments, the starting time point of the first SDT procedure may be a time point that the first SDT procedure is initiated. In some embodiments, the starting time point of the first SDT procedure may be a time point in which a paging message associated with the first SDT procedure is received.

In some embodiments, the starting time point of the second SDT procedure may be a time point in which data associated with the second SDT procedure arrives. In some embodiments, the starting time point of the second SDT procedure may be a time point in which the data associated with the second SDT procedure is transmitted. In some embodiments, the starting time point of the second SDT procedure may be a time point in which an RRC resume procedure associated with the second SDT procedure is initiated. In some embodiments, the starting time point of the second SDT procedure may be a time point in which a set of conditions for initiating the second SDT procedure is fulfilled. In some embodiments, the starting time point of the second SDT procedure may be a time point in which a paging message associated with the second SDT procedure is received.

Based on the starting time points of the first and second SDT procedures, the UE 104 may select one of the first and second SDT procedures as the ongoing procedure. In some embodiments, if the starting time point of the first SDT procedure is earlier than the starting time point of the second SDT procedure, the UE 104 may select the first SDT procedure as the ongoing procedure. That is, a procedure starting first may be selected. In some embodiments, if there is already an ongoing SDT procedure, there may not be another SDT procedure. In some embodiments, there is only one ongoing SDT procedure.

In some alternative embodiments, if the starting time point of the first SDT procedure is later than the starting time point of the second SDT procedure, the UE 104 may select the first SDT procedure as the ongoing procedure. That is, a procedure starting later may be selected.

In some embodiments, if the starting time point of the first SDT procedure is equal to the starting time point of the second SDT procedure, the UE 104 may select one of the first and second SDT procedures based on its implementation. In some embodiments, if a resource to respond to a paging message associated with an MT-SDT and a resource for an MO-SDT are in the same time slot or time duration or symbol, the UE 104 may select one of the first and second SDT procedures based on its implementation.

In some embodiments, information of whether the procedure starting first or the procedure starting later is selected may be predefined. In some embodiments, the information of whether the procedure starting first or the procedure starting later is selected may be configured or indicated by the network entity 102.

Continuing to refer to FIG. 3, in some embodiments, the UE 104 may determine 323 a first resource selected for the first SDT procedure and a second resource selected for the second SDT procedure. Based on priorities of the first and second resources, the UE 104 may select, as the ongoing procedure, one of the first and second SDT procedures.

In some embodiments, the priorities of the first and second resources may be predefined. In some embodiments, the priorities of the first and second resources may be configured. For example, a CG-SDT resource may be prior to an RA-SDT resource, and an RA-SDT resource may be prior to a non-SDT RA resource. In another example, a non-SDT RA resource may be prior to a CG-SDT resource, and a CG-SDT resource may be prior to an RA-SDT resource. It is to be understood that the present disclosure does not limit the priorities of the first and second resources.

In some embodiments, a procedure to be initiated or triggered to transmit via a resource with a higher priority may be considered as the ongoing procedure. In some embodiments, a procedure to be initiated or triggered to transmit via a resource with a lower priority may be considered as the ongoing procedure.

In some embodiments, the priorities of the first and second resources may be the same. In this case, it is up to UE implementation to select one of the procedures as the ongoing procedure. In some embodiments, if the procedures select the same resource, the UE 104 may select one of the procedures as the ongoing procedure based on its implementation. In some embodiments, if the procedures select the resource in the same slot or mini slot or subframe or frame or symbol or duration, the UE 104 may select one of the procedures as the ongoing procedure based on its implementation. In some embodiments, if the same resource can be used to transmit an MO-SDT or respond to a paging message associated with an MT-SDT, the UE 104 may select one of the procedures as the ongoing procedure based on its implementation.

In some alternative embodiments, if the priorities of the first and second resources are the same, the UE 104 may further determine the ongoing procedure based on the information of prioritization among the first and second SDT procedures. In some alternative embodiments, if the priorities of the first and second resources are the same, the UE 104 may further determine the ongoing procedure based on the starting time points of the first and second SDT procedures.

Continuing to refer to FIG. 3, the UE 104 may cancel or stop or suspend 330 one of the first and second SDT procedures that is unselected as the ongoing procedure. In some embodiments, the UE 104 may consider or determine that the cancelled or stopped or suspended procedure is successfully completed.

In some embodiments, the UE 104 may consider or determine that the cancelled or stopped or suspended procedure is unsuccessfully completed. In these embodiments, the UE 104 may maintain in an inactive state. In other words, if a SDT is considered as unsuccessfully completed because the SDT is unselected as an ongoing procedure, the UE 104 may maintain in the inactive state or may not cause state transition.

Continuing to refer to FIG. 3, in some embodiments, the UE 104 may transmit 340, to the network entity 103, information of the determination of the ongoing procedure. In some embodiments, the information may indicate that there are UL and DL small data to be transmitted and received. In some embodiments, the information may indicate that MO-SDT or MT-SDT is stopped or cancelled or suspended or unselected. In some embodiments, the information may indicate that there is another SDT to be handled. It is to be understood that any other suitable forms may also be feasible.

In some embodiments, the UE 104 may transmit a message indicating the information of the determination of the ongoing procedure. In some embodiments, the message may have a cause value indicating the information of the determination of the ongoing procedure. In some embodiments, the message may have an information element (IE) indicating the information of the determination of the ongoing procedure. For example, the message may be an RRC message such as an RRC resume request message, a UE assistance information message, and any other suitable RRC messages.

In some embodiments, the UE 104 may transmit a medium access control (MAC) control element (CE) indicating the information of the determination of the ongoing procedure. It is to be understood that any other suitable ways may also be feasible for transmitting the information of the determination of the ongoing procedure.

So far, the handling of overlap among at least SDT procedures is described. With the process 300, an interaction among SDT procedures may be simplified, and communication efficiency may be improved.

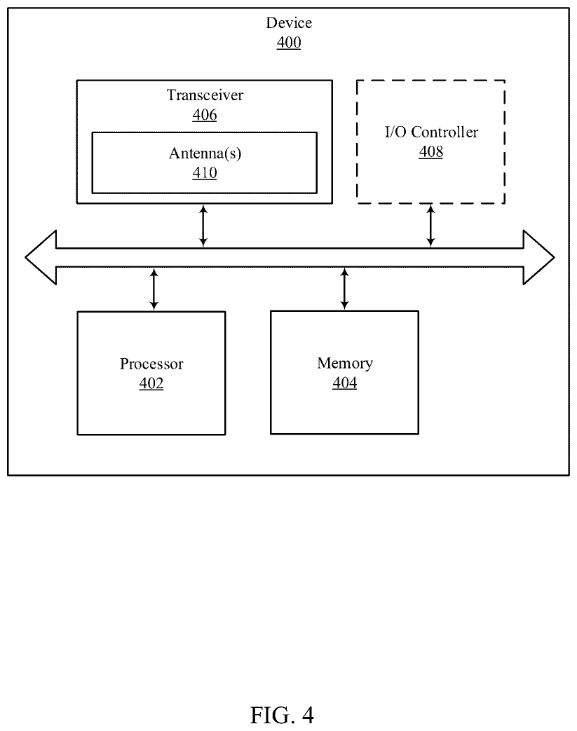

FIG. 4 illustrates an example of a device 400 that supports handling of overlap among at least SDT procedures in accordance with aspects of the present disclosure. The device 400 may be an example of the UE 104 as described herein. The device 400 may support wireless communication with one or more network entities 102, UEs 104, or any combination thereof. The device 400 may include components for bi-directional communications including components for transmitting and receiving communications, such as a processor 402, a memory 404, a transceiver 406, and, optionally, an I/O controller 408. These components may be in electronic communication or otherwise coupled (e.g., operatively, communicatively, functionally, electronically, electrically) via one or more interfaces (e.g., buses).

The processor 402, the memory 404, the transceiver 406, or various combinations thereof or various components thereof may be examples of means for performing various aspects of the present disclosure as described herein. For example, the processor 402, the memory 404, the transceiver 406, or various combinations or components thereof may support a method for performing one or more of the operations described herein.

In some implementations, the processor 402, the memory 404, the transceiver 406, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 402 and the memory 404 coupled with the processor 402 may be configured to perform one or more of the functions described herein (e.g., executing, by the processor 402, instructions stored in the memory 404).

For example, the processor 402 may support wireless communication at the device 400 in accordance with examples as disclosed herein. The processor 402 may be configured to operable to support a means for determining that a first SDT procedure overlaps at least with a second SDT procedure and determining an ongoing procedure.

The processor 402 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 402 may be configured to operate a memory array using a memory controller. In some other implementations, a memory controller may be integrated into the processor 402. The processor 402 may be configured to execute computer-readable instructions stored in a memory (e.g., the memory 404) to cause the device 400 to perform various functions of the present disclosure.

The memory 404 may include random access memory (RAM) and read-only memory (ROM). The memory 404 may store computer-readable, computer-executable code including instructions that, when executed by the processor 402 cause the device 400 to perform various functions described herein. The code may be stored in a non-transitory computer-readable medium such as system memory or another type of memory. In some implementations, the code may not be directly executable by the processor 402 but may cause a computer (e.g., when compiled and executed) to perform functions described herein. In some implementations, the memory 404 may include, among other things, a basic I/O system (BIOS) which may control basic hardware or software operation such as the interaction with peripheral components or devices.

The I/O controller 408 may manage input and output signals for the device 400. The I/O controller 408 may also manage peripherals not integrated into the device 400. In some implementations, the I/O controller 408 may represent a physical connection or port to an external peripheral. In some implementations, the I/O controller 408 may utilize an operating system such as iOS®, ANDROID®, MS-WINDOWS®, OS/2®, UNIX®, LINUX®, or another known operating system. In some implementations, the I/O controller 408 may be implemented as part of a processor, such as the processor 406. In some implementations, a user may interact with the device 400 via the I/O controller 408 or via hardware components controlled by the I/O controller 408.

In some implementations, the device 400 may include a single antenna 410. However, in some other implementations, the device 400 may have more than one antenna 410 (i.e., multiple antennas), including multiple antenna panels or antenna arrays, which may be capable of concurrently transmitting or receiving multiple wireless transmissions. The transceiver 406 may communicate bi-directionally, via the one or more antennas 410, wired, or wireless links as described herein. For example, the transceiver 406 may represent a wireless transceiver and may communicate bi-directionally with another wireless transceiver. The transceiver 406 may also include a modem to modulate the packets, to provide the modulated packets to one or more antennas 410 for transmission, and to demodulate packets received from the one or more antennas 410. The transceiver 406 may include one or more transmit chains, one or more receive chains, or a combination thereof.

A transmit chain may be configured to generate and transmit signals (e.g., control information, data, packets). The transmit chain may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmit chain may also include at least one power amplifier configured to amplify the modulated signal to an appropriate power level suitable for transmission over the wireless medium. The transmit chain may also include one or more antennas 410 for transmitting the amplified signal into the air or wireless medium.

A receive chain may be configured to receive signals (e.g., control information, data, packets) over a wireless medium. For example, the receive chain may include one or more antennas 410 for receive the signal over the air or wireless medium. The receive chain may include at least one amplifier (e.g., a low-noise amplifier (LNA)) configured to amplify the received signal. The receive chain may include at least one demodulator configured to demodulate the receive signal and obtain the transmitted data by reversing the modulation technique applied during transmission of the signal. The receive chain may include at least one decoder for decoding the processing the demodulated signal to receive the transmitted data.

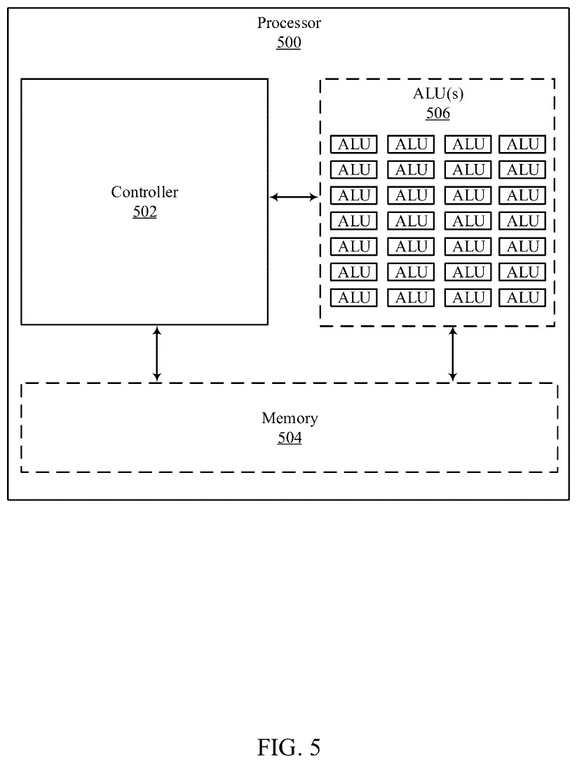

FIG. 5 illustrates an example of a processor 500 that supports handling of overlap among at least SDT procedures in accordance with aspects of the present disclosure. The processor 500 may be an example of a processor configured to perform various operations in accordance with examples as described herein. The processor 500 may include a controller 502 configured to perform various operations in accordance with examples as described herein. The processor 500 may optionally include at least one memory 504, such as L1/L2/L3 cache. Additionally, or alternatively, the processor 500 may optionally include one or more arithmetic-logic units (ALUs) 506. One or more of these components may be in electronic communication or otherwise coupled (e.g., operatively, communicatively, functionally, electronically, electrically) via one or more interfaces (e.g., buses).

The processor 500 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 500) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 502 may be configured to manage and coordinate various operations (e.g., signaling, receiving, obtaining, retrieving, transmitting, outputting, forwarding, storing, determining, identifying, accessing, writing, reading) of the processor 500 to cause the processor 500 to support various operations in accordance with examples as described herein. For example, the controller 502 may operate as a control unit of the processor 500, generating control signals that manage the operation of various components of the processor 500. These control signals include enabling or disabling functional units, selecting data paths, initiating memory access, and coordinating timing of operations.

The controller 502 may be configured to fetch (e.g., obtain, retrieve, receive) instructions from the memory 504 and determine subsequent instruction(s) to be executed to cause the processor 500 to support various operations in accordance with examples as described herein. The controller 502 may be configured to track memory address of instructions associated with the memory 504. The controller 502 may be configured to decode instructions to determine the operation to be performed and the operands involved. For example, the controller 502 may be configured to interpret the instruction and determine control signals to be output to other components of the processor 500 to cause the processor 500 to support various operations in accordance with examples as described herein. Additionally, or alternatively, the controller 502 may be configured to manage flow of data within the processor 500. The controller 502 may be configured to control transfer of data between registers, arithmetic logic units (ALUs), and other functional units of the processor 500.

The memory 504 may include one or more caches (e.g., memory local to or included in the processor 500 or other memory, such RAM, ROM, DRAM, SDRAM, SRAM, MRAM, flash memory, etc. In some implementation, the memory 504 may reside within or on a processor chipset (e.g., local to the processor 500). In some other implementations, the memory 504 may reside external to the processor chipset (e.g., remote to the processor 500).

The memory 504 may store computer-readable, computer-executable code including instructions that, when executed by the processor 500, cause the processor 500 to perform various functions described herein. The code may be stored in a non-transitory computer-readable medium such as system memory or another type of memory. The controller 502 and/or the processor 500 may be configured to execute computer-readable instructions stored in the memory 504 to cause the processor 500 to perform various functions. For example, the processor 500 and/or the controller 502 may be coupled with or to the memory 504, and the processor 500, the controller 502, and the memory 504 may be configured to perform various functions described herein. In some examples, the processor 500 may include multiple processors and the memory 504 may include multiple memories. One or more of the multiple processors may be coupled with one or more of the multiple memories, which may, individually or collectively, be configured to perform various functions herein.

The one or more ALUs 506 may be configured to support various operations in accordance with examples as described herein. In some implementation, the one or more ALUs 506 may reside within or on a processor chipset (e.g., the processor 500). In some other implementations, the one or more ALUs 506 may reside external to the processor chipset (e.g., the processor 500). One or more ALUs 506 may perform one or more computations such as addition, subtraction, multiplication, and division on data. For example, one or more ALUs 506 may receive input operands and an operation code, which determines an operation to be executed. One or more ALUs 506 be configured with a variety of logical and arithmetic circuits, including adders, subtractors, shifters, and logic gates, to process and manipulate the data according to the operation. Additionally, or alternatively, the one or more ALUs 506 may support logical operations such as AND, OR, exclusive-OR (XOR), not-OR (NOR), and not-AND (NAND), enabling the one or more ALUs 506 to handle conditional operations, comparisons, and bitwise operations.

The processor 500 may support wireless communication in accordance with examples as disclosed herein. The processor 500 may be configured to or operable to support a means for determining that a first SDT procedure overlaps at least with a second SDT procedure and determining an ongoing procedure.

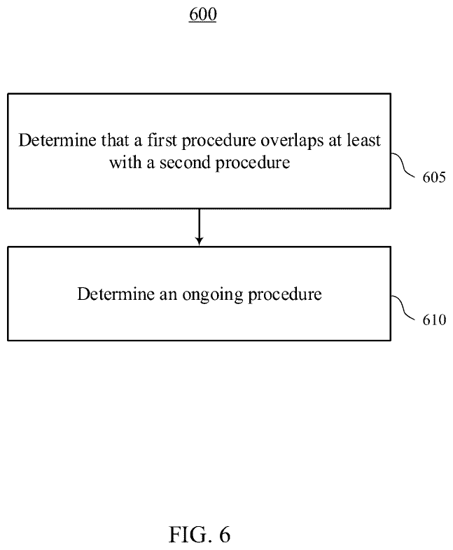

FIG. 6 illustrates a flowchart of a method 600 that supports handling of overlap among at least SDT procedures in accordance with aspects of the present disclosure. The operations of the method 600 may be implemented by a device or its components as described herein. For example, the operations of the method 600 may be performed by the UE 104 as described herein. In some implementations, the device may execute a set of instructions to control the function elements of the device to perform the described functions. Additionally, or alternatively, the device may perform aspects of the described functions using special-purpose hardware.

At block 605, the method 600 may include determining that a first SDT procedure overlaps at least with a second SDT procedure. The operations of 605 may be performed in accordance with examples as described herein. In some implementations, aspects of the operations of 605 may be performed by a device as described with reference to FIG. 1.

In some embodiments, determining that the first SDT procedure overlaps at least with the second SDT procedure may comprise: determining that the first SDT procedure and the second SDT procedure are started. In some embodiments, determining that the first SDT procedure overlaps at least with the second SDT procedure may comprise: determining that the first SDT procedure, the second SDT procedure and a non-SDT procedure are started.

In some embodiments, the first SDT procedure may be an MO-SDT procedure or an MT-SDT procedure. In some embodiments, the second SDT procedure may be the MO-SDT procedure or the MT-SDT procedure.

At block 610, the method 600 may include determining an ongoing procedure. The operations of 610 may be performed in accordance with examples as described herein. In some implementations, aspects of the operations of 610 may be performed by a device as described with reference to FIG. 1.

In some embodiments, determining the ongoing procedure may comprise: determining a starting time point of the first SDT procedure and a starting time point of the second SDT procedure; and selecting, as the ongoing procedure, one of the first and second SDT procedures based on the starting time point of the first SDT procedure and the starting time point of the second SDT procedure.

In some embodiments, the starting time point of the first SDT procedure may be one of the following: a time point in which data associated with the first SDT procedure arrives; a time point in which the data associated with the first SDT procedure is transmitted; a time point in which an RRC resume procedure associated with the first SDT procedure is initiated; a time point in which a set of conditions for initiating the first SDT procedure is fulfilled; or a time point in which a paging message associated with the first SDT procedure is received.

In some embodiments, the starting time point of the second SDT procedure may be one of the following: a time point in which data associated with the second SDT procedure arrives; a time point in which the data associated with the second SDT procedure is transmitted; a time point in which an RRC resume procedure associated with the second SDT procedure is initiated; a time point in which a set of conditions for initiating the second SDT procedure is fulfilled; or a time point in which a paging message associated with the second SDT procedure is received.

In some embodiments, determining the ongoing procedure may comprise: determining a first resource selected for the first SDT procedure and a second resource selected for the second SDT procedure; and selecting, as the ongoing procedure, one of the first and second SDT procedures based on priorities of the first and second resources.

In some embodiments, the method 600 may further include: cancelling or stopping or suspending one of the first and second SDT procedures that is unselected as the ongoing procedure.

In some embodiments, the method 600 may further include: determining that the one of the first and second SDT procedures is unsuccessfully completed. In some embodiments, the method 600 may further include: determining that the one of the first and second SDT procedures is successfully completed.

In some embodiments, the method 600 may further include: in accordance with a determination that the one of the first and second SDT procedures is unsuccessfully completed, maintaining in an inactive state.

In some embodiments, the method 600 may further include: transmitting, to the network entity 104, information of the determination of the ongoing procedure.

In some embodiments, transmitting the information of the determination of the ongoing procedure may comprise: transmitting a message indicating the information of the determination of the ongoing procedure. In some embodiments, the message may have a cause value indicating the information of the determination of the ongoing procedure. In some embodiments, the message may have an information element indicating the information of the determination of the ongoing procedure.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE), comprising:
at least one memory;
at least one processor coupled with the at least one memory and configured to cause the UE to:
determine that a first small data transmission (SDT) procedure overlaps at least with a second SDT procedure; and
determine an ongoing procedure.

2. The UE of claim 1, wherein to determine that the first SDT procedure overlaps at least with the second SDT procedure, the at least one processor is configured to cause the UE to:
determine that the first SDT procedure and the second SDT procedure are started; or
determine that the first SDT procedure, the second SDT procedure and a non-SDT procedure are started.

3. The UE of claim 2, wherein the first SDT procedure is a mobile originating-small data transmission (MO-SDT) procedure or a mobile terminating-small data transmission (MT-SDT) procedure, and
wherein the second SDT procedure is the MO-SDT procedure or the MT-SDT procedure.

4. The UE of claim 1, wherein to determine the ongoing procedure, the at least one processor is configured to cause the UE to:
determine information of prioritization among the first SDT procedure and the second SDT procedure; and
select, based at least in part on the information of the prioritization, one of the first SDT procedure and the second SDT procedure as the ongoing procedure.

5. The UE of claim 4, wherein to determine the information of the prioritization, the at least one processor is configured to cause the UE to:
receive an indication comprising the information of the prioritization.

6. The UE of claim 5, wherein to receive the indication comprising the information of the prioritization, the at least one processor is configured to cause the UE to:
receive the indication in a paging message associated with a mobile terminating-small data transmission (MT-SDT) procedure.

7. The UE of claim 4, wherein the information of the prioritization indicates:
a mobile originating-small data transmission (MO-SDT) procedure is prior to a mobile terminating-small data transmission (MT-SDT) procedure; or
the MT-SDT procedure is prior to the MO-SDT procedure.

8. The UE of claim 1, wherein to determine the ongoing procedure, the at least one processor is configured to cause the UE to:
determine a starting time point of the first SDT procedure and a starting time point of the second SDT procedure; and
select, as the ongoing procedure, one of the first SDT procedure and the second SDT procedure based at least in part on the starting time point of the first SDT procedure and the starting time point of the second SDT procedure.

9. The UE of claim 8, wherein the starting time point of the first SDT procedure is one of:
a time point in which data associated with the first SDT procedure arrives;
a time point in which the data associated with the first SDT procedure is transmitted;
a time point in which a radio resource control (RRC) resume procedure associated with the first SDT procedure is initiated;
a time point in which a set of conditions for initiating the first SDT procedure is fulfilled; or
a time point in which a paging message associated with the first SDT procedure is received.

10. The UE of claim 8, wherein the starting time point of the second SDT procedure is one of:
a time point in which data associated with the second SDT procedure arrives;
a time point in which the data associated with the second SDT procedure is transmitted;
a time point in which a radio resource control (RRC) resume procedure associated with the second SDT procedure is initiated;
a time point in which a set of conditions for initiating the second SDT procedure is fulfilled; or
a time point in which a paging message associated with the second SDT procedure is received.

11. The UE of claim 1, wherein to determine the ongoing procedure, the at least one processor is further configured to cause the UE to:
determine a first resource selected for the first SDT procedure and a second resource selected for the second SDT procedure; and
select, as the ongoing procedure, one of the first SDT procedure and the second SDT procedure based at least in part on priorities of the first resource and the second resource.

12. The UE of claim 1, wherein the at least one processor is further configured to cause the UE to:
cancel or stop or suspend one of the first SDT procedure and the second SDT procedure that is unselected as the ongoing procedure.

13. The UE of claim 12, wherein the at least one processor is further configured to cause the UE to:
determine that the one of the first SDT procedure and the second SDT procedure is unsuccessfully completed; or
determine that the one of the first SDT procedure and the second SDT procedure is successfully completed.

14. (canceled)

15. The UE of claim 1, wherein the at least one processor is further configured to cause the UE to:
transmit information of the determination of the ongoing procedure.

16. The UE of claim 15, wherein to transmit the information of the ongoing procedure, the at least one processor is configured to cause the to:
transmit a message indicating the information of the determination of the ongoing procedure.

17. (canceled)

18. A processor for wireless communication, comprising:
at least one memory; and
a controller coupled with the at least one memory and configured to cause the processor to:
determine that a first small data transmission (SDT) procedure overlaps at least with a second SDT procedure; and
determine an ongoing procedure.

19. The processor of claim 18, wherein to determine the ongoing procedure, the at least one controller is configured to cause the processor to:
determine information of prioritization among the first SDT procedure and the second SDT procedure; and
select, based at least in part on the information of the prioritization, one of the first and second SDT procedures as the ongoing procedure.

20. A method performed by a user equipment (UE), the method comprising:
determining that a first small data transmission (SDT) procedure overlaps at least with a second SDT procedure; and
determining an ongoing procedure.

21. The method of claim 20, wherein determining that the first SDT procedure overlaps at least with the second SDT procedure comprises:
determining that the first SDT procedure and the second SDT procedure are started; or
determining that the first SDT procedure, the second SDT procedure and a non-SDT procedure are started.

22. The UE of claim 1, wherein to determine the ongoing procedure, the at least one processor is further configured to cause the UE to:
determine a first resource selected for the first SDT procedure and a second resource selected for the second SDT procedure are a same resource; and
select, as the ongoing procedure, one of the first SDT procedure and the second SDT procedure.
